(19) United States
(12) Patent Application Publication
(10) Pub. No.: US 2020/0319853 A1
(43) Pub. Date: Oct. 8, 2020

(54) RANDOM NUMBER GENERATION SYSTEM, RANDOM NUMBER GENERATION METHOD, AND RANDOM NUMBER GENERATION PROGRAM

(71) Applicant: NEC Corporation, Minato-ku, Tokyo (JP)

(72) Inventors: Yuki TANAKA, Tokyo (JP); Kentarou SASAKI, Tokyo (JP); Kazuhiko MINEMATSU, Tokyo (JP)

(73) Assignee: NEC Corporation, Minato-ku, Tokyo (JP)

(21) Appl. No.: 16/753,077

(22) PCT Filed: Oct. 4, 2017
(86) PCT No.: PCT/JP2017/036162

§ 371 Date: Apr. 2, 2020

(51) Int. Cl. G06F 7/58; G06F 17/16; G06F 17/18; H04L 9/30

(52) U.S. Cl. CPC G06F 7/582; H04L 9/3093; G06F 17/18; G06F 17/16

(57) ABSTRACT

The random number generation system 10 includes: a first generation means 11 that generates a random number according to a one-dimensional discrete Gaussian distribution on a first lattice that is a lattice comprising an addition vector obtained by adding the second vector to the first vector and a subtraction vector obtained by subtracting the second vector from the first vector; a second generation means 12 that generates a random number according to a one-dimensional discrete Gaussian distribution on a second lattice that is the first lattice in which a vector obtained by dividing the sum of the addition vector and the subtraction vector by 2 is added; and an instruction means 13 that instructs the first generation means 11 or the second generation means 12 to generate a random number.

### TECHNICAL FIELD

The present invention relates to a random number generation system, a random number generation method, and a random number generation program, and in particular, relates to a random number generation system, a random number generation method, and a random number generation program that are used for encryption using a lattice and for a signature algorithm.

### BACKGROUND ART

(Regarding Cryptosystem using Lattice)

In a cryptosystem using a lattice (hereinafter, referred to as lattice encryption), processing is often performed in parallel. Further, lattice encryption is a cryptosystem that is easy to implement from a viewpoint of both hardware and software. In addition, lattice encryption is a cryptosystem in which computation is performed on a small modulus.

Non Patent Literatures (NPLs) 1 to 3 describe a study on practicality of lattice encryption. Further, attention has also been paid to a function derived from simplicity of computation peculiar to the lattice. For example, NPLs 4 to 8 describe a study on a function of fully homomorphic encryption.

Further, NPLs 9 and 10 describe a study on a function of ID-based encryption (IBE). In addition, NPL 11 describes a study on a function of attribute-based encryption (ABE) in an arbitrary circuit.

Further, it is known that RSA encryption and elliptic encryption can be decrypted when a quantum computer is used. However, NPL 12 describes that lattice encryption is a candidate for encryption that is resistant to a quantum computer (it is difficult to decipher even if a quantum computer is used).

### (Regarding Lattice-Based Encryption Application Technology)

In particular, in many encryption application technologies such as Hash then Signature, IBE, ABE, and chosen ciphertext attack (CCA) security encryption, a trapdoor one-way function is used.

The trapdoor one-way function is a special function in a one-way function family. An algorithm that generates the trapdoor one-way function also outputs additional information that enables computation of an inverse image of the function.

Specifically, the trapdoor one-way function is a function that is difficult to compute an inverse image (input value) satisfying a condition without additional information and is a function that enables computation of the inverse image (input value) with additional information when a one-way function and an output value of the one-way function are given. The additional information is called trapdoor. The function of the one-way function family with additional information is the trapdoor one-way function.

In a trapdoor one-way function using a lattice, a basis vector (hereinafter, also simply referred to as a basis) generated on the basis of a short vector among basis vectors constituting the lattice serves as a trapdoor. The trapdoor one-way function using a lattice is used in, for example, goldreich-goldwasser-halevi (GGH)-Proposal.

However, security of the GGH-Proposal encryption method has not been proven at the beginning. Thereafter, Nguyen and Regev have proved that GGH-Proposal is not a secure encryption method.

As described in NPLs 18, 10, and, 17, various construction methods have been proposed as a construction method of an encryption application technology using the trapdoor one-way function using a lattice, even after GGH-Proposal. In particular, various encryption application technologies are constructed by using a method described in NPL 17.

Furthermore, a construction method described in NPL 10 is a construction method in which the construction method described in NPL 17 is improved by a technique called convolution described in NPL 16. Among currently known construction methods of the encryption application technology using the trapdoor one-way function using a lattice, the construction method described in NPL 10 is considered to be the best method in terms of ease of implementation and efficiency.

Note that the construction method described in NPL 10 is a method for efficiently sampling a modulus expressed by a power of a certain number. NPL 19 describes a method for efficiently sampling an arbitrary modulus. For example, encryption application technologies described in NPLs 13 to 15 are constructed on an arbitrary modulus.

As described above, lattice encryption is being studied as a candidate for practical encryption, encryption that provides advanced functions, and encryption that is resistant to quantum computers. Improvement of efficiency of the construction of the trapdoor one-way function using a lattice serving as a component of various encryption application technologies is one of important issues that need to be realized in order to reduce a computational load in lattice encryption.

For example, an inverse image sampling algorithm is a construction algorithm of a trapdoor one-way function that is used at a time of signature generation or ABE key generation. Hereinafter, description is given to an inverse image sampling algorithm of a trapdoor one-way function in the construction method described in NPL 10, which is considered to be the most efficient.

In order to explain the inverse image sampling algorithm described in NPL 10, a trapdoor one-way function described in NPL 10 will be described.

The trapdoor one-way function described in NPL 10 is a surjection (there is always an input value corresponding to a range). In the inverse image sampling algorithm of the trapdoor one-way function, sampling for all inverse images is performed in accordance with an appropriate distribution.

FIG. 11 is an explanatory diagram showing an example of inverse image sampling of the trapdoor one-way function described in NPL 10. Sampling is performed on an inverse image represented by a dot on a left graph shown in FIG. 11.

In the inverse image sampling algorithm, for example, sampling according to a discrete Gaussian distribution is performed. It is difficult to execute the sampling according to the discrete Gaussian distribution on an inverse image close to an origin without secret information.

The reason is that, without secret information, it becomes difficult to find a basis vector having a short length even if a lattice is given. That is, without secret information, an inverse image closer to the origin (a basis vector having a shorter length) has a smaller probability of being discovered.

Hereinafter, the discrete Gaussian distribution will be described. It is assumed that the following function is defined by a real number σ □ R (R is a symbol representing a set of all real numbers).

$$\begin{matrix}[ Formula 1 ] & \\ φ ( x ) := \frac{1}{σ} exp ( - \frac{π}{{σ}^{2}} {\vert x \vert}^{2} ) & Equation ( 1 )\end{matrix}$$

Distribution outputted with an integer value u Z^{N} (Z is a symbol representing a set of whole integers) with a probability φ(u)/Σ^{∞}_{j=-∞}φ(j) is called a discrete Gaussian distribution on Z^{N} in which a variance value is σ, and described as D_{Z}^{N},_{σ}. In particular, φ(x) of σ=1 is described as ρ(x).

Hereinafter, the inverse image sampling algorithm of the trapdoor one-way function described in NPL 10 will be specifically described after description of some preparation items.

An inverse image sampling process described in NPL 10 is performed using a public key A and a trapdoor R generated in a process of generating a public key and a trapdoor. The inverse image sampling process is a process including an ON LINE phase and an OFF LINE phase.

First, symbols are organized. A lattice Λᵤ^{□}(A) with basis A □ Z^{n×m} is defined for A and u as follows.

[Formula 2]

Λᵤ^{⊥}(A)={\vec{z}∈Z^{m}:Az=u mod q} Equation (2)

Further, a primitive lattice matrix G is defined as follows.

$$\begin{matrix}[ Formula 3 ] & \\ G = [ \begin{matrix}{g}^{->} & … & 0 \\ ⋮ & ⋱ & ⋮ \\ 0 & … & {g}^{->}\end{matrix} ] ( {g}^{->} = ( 1 , 2 , … , {2}^{K - 1} ) ) & Equation ( 3 )\end{matrix}$$

Next, a process of generating a public key and a trapdoor will be described. The process of generating a public key and a trapdoor is a process of, with N Z as a security parameter, taking a parameter param=(K, N, q=2^{K}, M⁻=O(NK), M=M⁻+NK, σ=ω((logN)^{1/2}, α)) as an input, and outputting a matrix serving as a public key and a matrix serving as a trapdoor as outputs.

Note that symbols used in the text in the present description, such as “−”, and “→”, and “ ” should be originally written immediately above an immediately preceding character, but these are described immediately after such a character as described above due to restriction of text notation.

In equations, these symbols are described in original positions.

Further, O and ω are Landau symbols. O(NK) in M⁻=O(NK) means that M⁻ is a function that can be suppressed to equal to or less than NK even in a case of N→∞. Further, α is a parameter satisfying the following conditional expression.

[Formula 4]

1/α>σ·ω(\sqrt{(log N)})

First, a procedure for generating a matrix serving as a public key will be described. The public key A is generated as follows as a matrix in which each component is Z_{q}=Z/qZ.

[Formula 5]

A=(A̅|A̅R+HG) Equation (4)

Note that, as in Equation (4), the notation (E|F) for the matrices E and F means that the matrices E and F are arranged side by side. Further, A⁻ in Equation (4) is a matrix uniformly sampled from Z_{q}^{N×M-} . That is, A⁻ is an N-row M⁻-column matrix in which each component is Z_{q}.

Further, H in Equation (4) is a regular matrix of Z_{q}^{N×N}. That is, H is an N-row N-column regular matrix in which each component is Z_{q}.

Further, R Z^{M-×NK} in Equation (4) is a matrix in which each column vector is generated from a discrete Gaussian distribution on Z^{M-} whose variance value is σ.

Hereinafter, an inverse image sampling process executed in accordance with the inverse image sampling algorithm will be described. Inputs to the inverse image sampling process are the public key A, the trapdoor R, the regular matrix H, a vector u^{→}, and a variance value s. Further, outputs of the inverse image sampling process include a random number according to a discrete Gaussian distribution with a variance value s on the lattice of Equation (2). Note that the variance value s in this process is expressed as follows.

$$s = \sqrt{\frac{2 n log q}{π}} ω ( \sqrt{log n} ) \qquad [ Formula 6 ]$$

FIG. 12 is an explanatory diagram showing an example of the inverse image sampling process described in NPL 10. Hereinafter, the inverse image sampling process will be described with reference to FIG. 12.

### [OFF LINE Step 1]

In OFF LINE step 1, a perturbation vector is generated as follows.

$$1. {p}^{->} ← {D}_{z , \sqrt{2} \cdot ω ( \sqrt{log n} )}^{n log q} \\ 2. [ \begin{matrix}- R \\ I\end{matrix} ] {p}^{->} \qquad [ Formula 7 ]$$

A vector generated as described above is newly determined as p^{→}. p^{→} shown in FIG. 12 is a perturbation vector.

### [OFF LINE Step 2]

In OFF LINE step 2, Ap^{→} is computed. The vector Ap^{→} shown in FIG. 12 may be a long vector.

### [ON LINE Step 1]

In ON LINE step 1, when a vector v^{→} is given, the vector u^{→} is generated as follows.

$$1. {{v}^{->}}^{′} ← {v}^{->} - A {p}^{->} \\ 2. {s}^{->} ← {D}_{{Λ}_{{v}^{->}}^{⊥} ( G )} \\ 3. {u}^{->} ← [ \begin{matrix}- R \\ I\end{matrix} ] {s}^{->} \qquad [ Formula 8 ]$$

Note that, as shown in FIG. 12, among vectors that become v^{→}−Ap^{→} when A is applied, a short vector is sampled as u^{→}.

### [ON LINE Step 2]

Finally, p^{→}+u^{→} is computed and outputted in ON LINE step 2. A vector “output” shown in FIG. 12 is the computed vector.

### CITATION LIST

### Non Patent Literature

NPL 1: Richard Lindner and Chris Peikert, “Better Key Sizes (and Attacks) for LWE-Based Encryption”, In CT-RSA, Springer, 2011, volume 6558 of Lecture Notes in Computer Science, pages 319-339.

NPL 2: Leo Ducas, Alain Durmus, Tancrede Lepoint, and Vadim Lyubashevsky, “Lattice Signatures and Bimodal Gaussians”, IACR Cryptology ePrint Archive, 2013, pages 383-423.

NPL 3: Erdem Alkim, Leo Ducas, Thomas Poppelmann, and Peter Schwabe, “Post-quantum key exchange—a new hope”, IACR Cryptology ePrint Archive, 2016, pages 1092-1113.

NPL 4: Zvika Brakerski, Craig Gentry, and Vinod Vaikuntanathan, “Fully Homomorphic Encryption without Bootstrapping”, ITCS '12 Proceedings of the 3rd Innovations in Theoretical Computer Science Conference, pages 309-325.

NPL 5: Zvika Brakerski and Vinod Vaikuntanathan, “Efficient Fully Homomorphic Encryption from (Standard) LWE”, In IEEE 52nd Annual Symposium on Foundations of Computer Science, FOCS 2011, Palm Springs, Calif., USA, October 22-25, 2011, pages 97-134.

NPL 6: Zvika Brakerski and Vinod Vaikuntanathan, “Fully Homomorphic Encryption from Ring-LWE and Security for Key Dependent Messages”, In CRYPTO, Springer, 2011, volume 6841 of Lecture Notes in Computer Science, pages 505-524.

NPL 7: Craig Gentry, “Fully Homomorphic Encryption Using Ideal Lattices”, In STOC, ACM, 2009, pages 169-178.

NPL 8: Craig Gentry and Shai Halevi, “Fully Homomorphic Encryption without Squashing Using Depth-3 Arithmetic Circuits”, IACR Cryptology ePrint Archive, 2011, pages 279-299.

NPL 9: David Cash, Dennis Hofheinz, Eike Kiltz, and Chris Peikert, “Bonsai Trees, or How to Delegate a Lattice Basis”, IACR Cryptology ePrint Archive, 2010, pages 591-626.

NPL 10: Daniele Micciancio and Chris Peikert, “Trapdoors for Lattices: Simpler, Tighter, Faster, Smaller”, In EUROCRYPT, Springer, 2012, volume 7237 of Lecture Notes in Computer Science, pages 700-740.

NPL 11: Sergey Gorbunov, Vinod Vaikuntanathan, and Hoeteck Wee, “Attribute-Based Encryption for Circuits”, J. ACM, 2015, 62(6), 45:1-45:34.

NPL 12: Peter W. Shor, “Polynomial-Time Algorithms for Prime Factorization and Discrete Logarithms on a Quantum Computer”, SIAM Review, 1999, 41(2), 303-332.

NPL 13: Vadim Lyubashevsky, Daniele Micciancio, Chris Peikert, and Alon Rosen, “SWIFFT: A Modest Proposal for FFT Hashing”, In Fast Software Encryption, 15th International Workshop, FSE 2008, Lausanne, Switzerland, Feb. 10-13, 2008, Revised Selected Papers, pages 54-69.

NPL 14: Craig Gentry, Shai Halevi, Chris Peikert, and Nigel P. Smart, “Field Switching in BGV-Style Homomorphic Encryption”, Journal of Computer Security, 2013, 21(5), pages 663-680.

NPL 15: Zvika Brakerski, Vinod Vaikuntanathan, Hoeteck Wee, and Daniel Wichs, “Obfuscating Conjunctions under Entropic Ring LWE”, In Proceedings of the 2016 ACM Conference on Innovations in Theoretical Computer Science, Cambridge, Mass., USA, Jan. 14-16, 2016, pages 147-163.

NPL 16: Chris Peikert, “An Efficient and Parallel Gaussian Sampler for Lattices”, Advances in Cryptology—CRYPTO 2010, pages 80-98.

NPL 17: Craig Gentry, Chris Peikert, and Vinod Vaikuntanathan, “Trapdoors for Hard Lattices and New Cryptographic Constructions”, STOC, 2008, pages 197-234.

NPL 18: Miklos Ajtai, “Generating Hard Instances of Lattice Problems Extended abstract”, IBM Almaden Research Center, 1996, pages 99-108.

NPL 19: Daniele Micciancio and Nicholas Genise, “Faster Gaussian Sampling for Trapdoor Lattices with Arbitrary Modulus”, IACR Cryptology ePrint Archive, 2017, pages 308-328.

### SUMMARY OF INVENTION

### Technical Problem

In the inverse image sampling process described above, the ON LINE phase is a phase that directly affects efficiency of construction of the encryption application technology. Hereinafter, algorithm efficiency in the ON LINE phase will be considered.

An optimal algorithm for the ON LINE phase is classified depending on whether or not a modulus q when the method described in NPL 10 is executed is represented by a power of a certain number. When the modulus q is represented by a power of a certain number, the optimal algorithm for the ON LINE phase is the algorithm described in NPL 10.

However, NPL 10 does not describe an optimal algorithm for an arbitrary modulus that is not necessarily represented by a power of a certain number. In order to construct encryption application technologies described in NPLs 13 to 15 above, an algorithm for an arbitrary modulus is required.

As described above, NPL 19 describes a method for efficiently sampling an arbitrary modulus. However, a method described in NPL 19 has the following implementation problem.

A one-dimensional discrete Gaussian distribution is called multiple times in “2. s^{→}←D_{Λ}^{□}_{v′→}(G)” of ON LINE step 1 of the ON LINE phase. That is, a computation speed of the inverse image sampling process depends on the number of calls of the one-dimensional discrete Gaussian distribution and a type of the discrete Gaussian distribution. A discrete Gaussian distribution whose center and variance value are parameters is classified into a stable distribution and a dynamic distribution.

When the stable distribution is called, a random number can be generated by a Look-up-table method (also called a cumulative method) described in NPL 16. When a random number is generated by the look-up-table method, the number of operations is reduced, and the computation speed of the inverse image sampling process becomes relatively high.

When the dynamic distribution is called, a random number cannot be generated by the cumulative method because a center fluctuates. Therefore, when the dynamic distribution is called, a random number is generated by a generation algorithm having a relatively low computation speed due to a large number of operations, such as a rejection sampling method described in NPL 17.

In the method described in NPL 19, when K=(rounded-up integer value of log(q)) is satisfied for the modulus q of the lattice, the process of 2. of ON LINE step 1 of the ON LINE phase of one inverse image sampling process requires a call for K times of the dynamic discrete Gaussian distribution.

Since all called distributions are dynamic discrete Gaussian distributions, the computation speed of the inverse image sampling process decreases if the method described in NPL 19 is used as it is. In order to increase the computation speed, it is conceivable to reduce the number of calls of the discrete Gaussian distribution, or to increase the number of calls of the static discrete Gaussian distribution.

### Object of Invention

Therefore, to solve the above-described problem, an object of the present invention is to provide a random number generation system, a random number generation method, and a random number generation program that can increase a computation speed of an inverse image sampling process performed on an arbitrary modulus.

### Solution to Problem

The random number generation system according to the present invention is a random number generation system that generates a random number according to a discrete Gaussian distribution on a lattice in which a first vector and a second vector that are two vectors having equal lengths are basis vectors. The random number generation system includes: a first generation means that generates a random number according to a one-dimensional discrete Gaussian distribution on a first lattice that is a lattice comprising an addition vector obtained by adding the second vector to the first vector and a subtraction vector obtained by subtracting the second vector from the first vector; a second generation means that generates a random number according to a one-dimensional discrete Gaussian distribution on a second lattice that is the first lattice in which a vector obtained by dividing the sum of the addition vector and the subtraction vector by 2 is added; and an instruction means that instructs the first generation means or the second generation means to generate a random number.

The random number generation method according to the present invention is a random number generation method executed in a random number generation system that generates a random number according to a discrete Gaussian distribution on a lattice in which a first vector and a second vector that are two vectors having equal lengths are basis vectors. The random number generation method generates a random number by executing any one of: a first generation process of generating a random number according to a one-dimensional discrete Gaussian distribution on a first lattice that is a lattice comprising an addition vector obtained by adding the second vector to the first vector and a subtraction vector obtained by subtracting the second vector from the first vector; or a second generation process of generating a random number according to a one-dimensional discrete Gaussian distribution on a second lattice that is the first lattice in which a vector obtained by dividing the sum of the addition vector and the subtraction vector by 2 is added.

The random number generation program according to the present invention is a random number generation program executed in a computer that generates a random number according to a discrete Gaussian distribution on a lattice in which a first vector and a second vector that are two vectors having equal lengths are basis vectors. The random number generation program causes the computer to execute a generation process of generating a random number by executing any one of: a first generation process of generating a random number according to a one-dimensional discrete Gaussian distribution on a first lattice that is a lattice comprising an addition vector obtained by adding the second vector to the first vector and a subtraction vector obtained by subtracting the second vector from the first vector; or a second generation process of generating a random number according to a one-dimensional discrete Gaussian distribution on a second lattice that is the first lattice in which a vector obtained by dividing the sum of the addition vector and the subtraction vector by 2 is added.

### Advantageous Effects of Invention

According to the present invention, a computation speed of an inverse image sampling process executed on an arbitrary modulus can be increased.

### BRIEF DESCRIPTION OF DRAWINGS

FIG. 1 is an explanatory diagram showing an example of an algorithm for generating a random number according to a discrete Gaussian distribution whose origin is a center on each lattice.

FIG. 2 is an explanatory diagram showing an example of an algorithm for generating a random number according to a discrete Gaussian distribution in which a center on a lattice comprising SPL is an arbitrary value.

FIG. 3 is an explanatory diagram showing an example of an algorithm for generating a random number according to a discrete Gaussian distribution on SPL.

FIG. 4 is a block diagram showing a configuration example of a first exemplary embodiment of a random number generation system according to the present invention.

FIG. 5 is a block diagram showing a configuration example of a first random number generation device 1100 of the first exemplary embodiment.

FIG. 6 is a block diagram showing a configuration example of a second random number generation device 1200 of the first exemplary embodiment.

FIG. 7 is a block diagram showing a configuration example of an SPL random number generation means 1210₁ of the first exemplary embodiment.

FIG. 8 is a flowchart showing an operation of a random number generation process by a random number generation system 1000 of the first exemplary embodiment.

FIG. 9 is a flowchart showing an operation of an SPL random number generation process by the SPL random number generation means of the first exemplary embodiment.

FIG. 10 is a block diagram showing an outline of the random number generation system according to the present invention.

FIG. 11 is an explanatory diagram showing an example of inverse image sampling of a trapdoor one-way function described in NPL 10.

FIG. 12 is an explanatory diagram showing an example of an inverse image sampling process described in NPL 10.

### DESCRIPTION OF EMBODIMENTS

First, a process of “2. s^{→}←D_{Λ}^{□}_{v′}→(G)” of ON LINE step 1, which is a target part of the issue, will be briefly described. The procedure of 2. of ON LINE step 1 is a procedure for generating a random number according to a discrete Gaussian distribution whose origin is a center on a next lattice when v′^{→}=(v₁, . . . , vₙ).

$$\begin{matrix} [ Formula 9 ] & \\ \underbrace{( {v}_{1} , 0 , … , 0 )}_{K pieces of component} + Λ ( S ) ⊕ \underbrace{( {v}_{2} , 0 , … , 0 )}_{K pieces of component} + Λ ( S ) ⊕ … ⊕ \underbrace{( {v}_{n} , 0 , … , 0 )}_{K pieces of component} + Λ ( S ) & Equation ( 5 )\end{matrix}$$

S in Equation (5) is also called a dual primitive lattice matrix of a primitive lattice matrix G. A basis matrix of the dual primitive lattice matrix S is expressed as follows when the modulus g is q=2^{K}.

$$S = [ \begin{matrix}2 & 0 & … & & 0 \\ - 1 & 2 & 0 & … & 0 \\ 0 & - 1 & 2 & & 0 \\ & & & ⋱ & ⋮ \\ & & & - 1 & 2\end{matrix} ] \qquad [ Formula 10 ]$$

Further, when the modulus q is an arbitrary value and is expressed as q=q₀·1+q₁·2+. . . +qₖ₋₁·2^{k-1} (where qᵢ {0,1}), a basis matrix of the dual primitive lattice S is represented as follows.

$$S = [ \begin{matrix}2 & 0 & … & & {q}_{0} \\ - 1 & 2 & 0 & … & {q}_{1} \\ 0 & - 1 & 2 & & {q}_{2} \\ & & & ⋱ & ⋮ \\ & & & - 1 & {q}_{k - 1}\end{matrix} ] \qquad [ Formula 11 ]$$

A lattice Λ(S) for the matrix S=[s₁^{→}, . . . , s_{K}^{→}] in Equation (5) is a lattice having s₁^{→}, . . . , s_{K}^{→} as a basis.

In 2. of ON LINE step 1, the following random numbers (1) to (n) are generated in parallel.
(1) Random numbers (x₀¹, . . . , x_{K-1}¹) according to a discrete Gaussian distribution whose origin is a center on (v₁, 0, . . . , 0)+Λ(S);
(2) Random numbers (x₀², . . . , x_{K-1}²) according to a discrete Gaussian distribution whose origin is a center on (v₂, 0, . . . , 0)+Λ(S); . . .
(n) Random numbers (x₀ⁿ, . . . , x_{K-1}ⁿ) according to a discrete Gaussian distribution whose origin is a center on (vₙ, 0, . . . , 0)+Λ(S).

Finally, (x₀¹, . . . , x_{K-1}¹, x₀², . . . , x_{K-1}², . . . , x₀ⁿ, . . . , x_{K-1}ⁿ) are outputted as a generated random number. In the present exemplary embodiment, the method described in NPL 17 is used as a method for generating a random number according to a discrete Gaussian distribution whose origin is a center on each lattice described above.

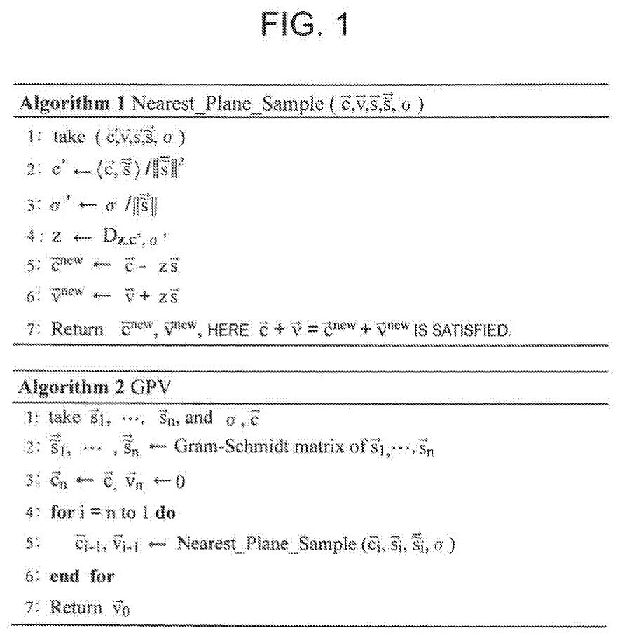

FIG. 1 shows an algorithm for generating a random number according to a discrete Gaussian distribution whose origin is a center on each lattice when the method described in NPL 17 is used. FIG. 1 is an explanatory diagram showing an example of an algorithm for generating a random number according to a discrete Gaussian distribution whose origin is a center on each lattice.

An inverse image sampling process in 2. of ON LINE step 1 is executed in accordance with an algorithm GPV shown in FIG. 1. In step 1. of the algorithm GPV, a basis vector, a variance value, and a center are inputted. Next, in step 2, respective Gram-Schmidt vectors s₁^{˜→}, . . . , sₙ^{˜→} of basis vectors s₁^{→}, . . . , sₙ^{→} are computed.

Next, in step 3, the inputted center is substituted to cₙ^{→}. Further, vₙ^{→} is set to 0. Note that the inputted center c^{→} shown in FIG. 1 is (v₁, 0, . . . , 0).

Then, in steps 4. to 6, an algorithm Nearest_Plane Sample is executed n times until all of cₙ₋₁^{→}, . . . , c₀^{→} and vₙ₋₁^{→}, . . . , v₀^{→} are computed. Finally, after v₀^{→} is outputted in step 7, the algorithm GPV is ended.

Next, the algorithm Nearest Plane Sample shown in FIG. 1 will be described. In step 1. of the algorithm Nearest_Plane_Sample, a center, a variance value, and the like are inputted. Next, the center is updated in step 2, and the variance value is updated in step 3. Next, in step 4, a random number according to a one-dimensional discrete Gaussian distribution based on the updated center and the updated variance value is generated.

Next, the center is updated using the generated random number in step 5, and the given vector is updated using the generated random number in step 6. Finally, after the updated center and the updated given vector are outputted in step 7,the algorithm Nearest_Plane_Sample is ended.

In the present exemplary embodiment, it is considered that the algorithm shown in FIG. 1 is improved so as to increase a computation speed of the inverse image sampling process executed on an arbitrary modulus. Three-dimensional vectors g^{→} and h^{→} used for description of the improvement contents are defined as the following vectors, respectively.

$${g}^{->} = [ \begin{matrix}2 \\ - 1 \\ 0\end{matrix} ] \\ {h}^{->} = [ \begin{matrix}0 \\ 2 \\ - 1\end{matrix} ] \qquad [ Formula 12 ]$$

When a random number according to a discrete Gaussian distribution on a lattice L whose bases are g^{→} and h^{→} is generated in accordance with the algorithm shown in FIG. 1, it has been required that a dynamic one-dimensional discrete Gaussian distribution is called twice consecutively, not in parallel.

However, attention is focused on that the lattice L is represented by a sum of a lattice L₁ and a lattice L₂ as follows, which are two lattices that do not overlap each other.

$${L}_{1} := Z [ \begin{matrix}2 \\ 1 \\ - 1\end{matrix} ] + Z [ \begin{matrix}2 \\ - 3 \\ 1\end{matrix} ] \\ {L}_{2} := {L}_{1} + [ \begin{matrix}2 \\ - 1 \\ 0\end{matrix} ] \qquad [ Formula 13 ]$$

Using the above feature, the algorithm GPV shown in FIG. 1 is changed to the following Superposition Lattice algorithm.

### Superposition Lattice Algorithm Step 1

The algorithm GPV generates a random number according to a discrete Gaussian distribution on a lattice. Further, in the algorithm GPV, a lattice on which a random number is generated is uniquely determined. In addition, since bases of the lattice are not necessarily orthogonal, and a center of the discrete Gaussian distribution is updated each time one random number is generated, a plurality of processes of generating a random number according to a dynamic discrete Gaussian distribution on a lattice are executed sequentially in principle.

In the Superposition Lattice algorithm, selection is made as to whether to generate a random number according to a discrete Gaussian distribution on the lattice L₁ or to generate a random number according to a discrete Gaussian distribution on the lattice L₂. Hereinafter, the selected lattice is referred to as L_{b}. Note that the Superposition Lattice means a lattice generated by two rectangles overlapping with each other.

### Superposition Lattice Algorithm Step 2

Next, a random number according to a discrete Gaussian distribution on a lattice L_{b} is generated. Next, the generated random number is outputted.

Note that, when a plurality of random numbers according to the discrete Gaussian distribution on the lattice L_{b} are generated, regardless of which of the lattice L₁ and the lattice L₂ is selected, a random number according to the discrete Gaussian distribution on the lattice L_{b} is generated when a static one-dimensional discrete Gaussian distribution is simply called once for each random number. That is, the process of generating each random number can be executed in parallel.

The reason is that the processes of generating a random number according to respective discrete Gaussian distributions can be executed in parallel since the center of the discrete Gaussian distribution on a lattice whose bases are orthogonal can be computed in advance on the basis of an input value. Two bases of the lattice L₁ are orthogonal. Further, two bases of the lattice L₂ are orthogonal.

When the algorithm is changed as described above, the random number generation processes in which the static one-dimensional discrete Gaussian distribution is called once are executed in parallel. That is, a speed of the process of generating a random number according to the discrete Gaussian distribution on the lattice L is increased.

The above algorithm will be described more specifically. As described above, a lattice generated by two rectangles overlapping with each other is defined as a Superposition Lattice (hereinafter, also referred to as SPL). When two orthogonal vectors a^{→} and b^{→} are given, a superposition lattice SPL (a^{→}, b^{→}) is defined as follows.

$$\begin{matrix} [ Formula 14 ] & \\ \underbrace{\{ α {a}^{->} + β {b}^{->} \vert α , β ∈ Z \}}_{{SPL}_{1} ( \overline{a} , \overline{b}} + \{ \frac{{a}^{->} + {b}^{->}}{2} + α {a}^{->} + β {b}^{->} \vert α , β ∈ Z \} ( {a}^{->} ⊥ {b}^{->} ) & Equation ( 6 )\end{matrix}$$

As shown in Equation (6), a first lattice is described as SPL₁ (a^{→}, b^{→}), and a second lattice is described as SPL₂ (a^{→}, b^{→}). There is the following relationship between the two lattices.

[Formula 15]

SPL₁(\vec{a},\vec{b})∩SPL₂(\vec{a},\vec{b})=ϕ

According to Equation (6), the lattice L whose basis is the above g^{→} and h^{→} is expressed as L=SPL(g^{→}+h^{→}, g^{→}−h^{→})=SPL₁(g^{→}+h^{→},g^{→}−h^{→})+SPL₂(g^{→}+h^{→}, g^{→}−h^{→}). The SPL is a lattice that can be generated on the basis of two bases having an equal length, such as g^{→} and h^{→}. The reason is that ∥g^{→}∥=∥h^{→}∥ is a necessary and sufficient condition of (g^{→}+h^{→}) (g^{→}−h^{→}). Hereinafter, (g^{→}+h^{→}) is also referred to as an addition vector, and (g^{→}−h^{→}) is also referred to as a subtraction vector.

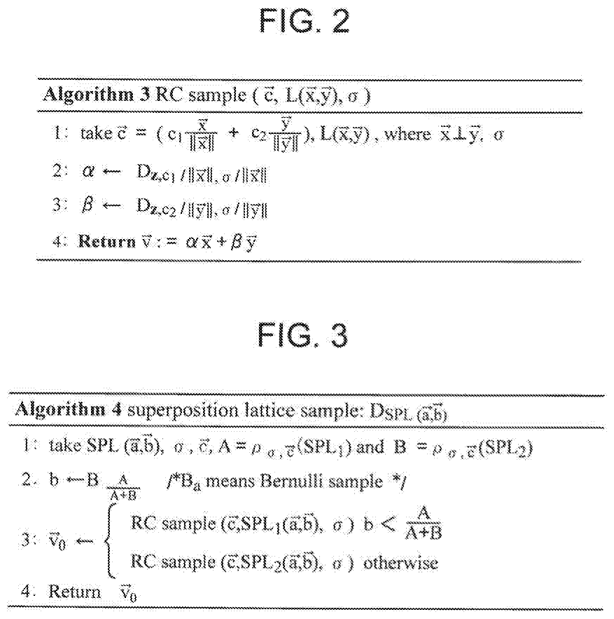

Next, a process of generating a random number according to a discrete Gaussian distribution on a lattice comprising the SPL is considered. FIG. 2 is an explanatory diagram showing an example of an algorithm for generating a random number according to a discrete Gaussian distribution in which a center on a lattice comprising SPL is an arbitrary value.

In step 1. of an algorithm RC sample shown in FIG. 2, a center, a lattice, and a variance value are inputted. A basis vector x^{→} and a basis vector y^{→} of the lattice L (x^{→}, y^{→}) are orthogonal.

Next, in step 2, a random number α according to a one-dimensional discrete Gaussian distribution on an x-axis is generated. Next, in step 3, a random number β according to a one-dimensional discrete Gaussian distribution on a y-axis is generated. Finally, after v^{→} is outputted in step 4, the algorithm RC sample is ended.

Steps 2. and 3. in the algorithm RC sample shown in FIG. 2 can be executed in parallel because center values are both independent. That is, the random numbers α and β according to the discrete Gaussian distribution on the lattice L (x^{→}, y^{→}) which is a lattice constituting the SPL, are generated in parallel.

A process of generating a random number according to a discrete Gaussian distribution on SPL using the algorithm shown in FIG. 2 is considered. FIG. 3 is an explanatory diagram showing an example of an algorithm for generating a random number according to a discrete Gaussian distribution on SPL.

In step 1. of an algorithm superposition lattice sample shown in FIG. 3, SPL, a variance value, and a center are inputted. Further, a value of A=ρ_{σ,c→} (SPL₁) and a value of B=ρ_{σ,c→} (SPL₂) are introduced. A is a probability that a random number according to a discrete Gaussian distribution on a lattice SPL₁ is generated. Further, B is a probability that a random number according to a discrete Gaussian distribution on a lattice SPL₂ is generated.

Then, in step 2, a uniform random number of b←B_{A/A+B} is generated. Next, in step 3, when the generated uniform random number b is smaller than A/(A+B), the algorithm RC sample given with the lattice SPL₁ is executed. Further, when the generated uniform random number b is equal to or larger than A/(A+B), the algorithm RC sample given with the lattice SPL₂ is executed.

By executing the algorithm RC sample in step 3, v₀^{→} (v^{→} shown in FIG. 2) is generated. Finally, after v₀^{→} is outputted in step 4, the algorithm superposition lattice sample is ended.

As described above, a random number according to the discrete Gaussian distribution on the SPL is generated by executing the algorithm superposition lattice sample shown in FIG. 3.

### [Description of Configuration]

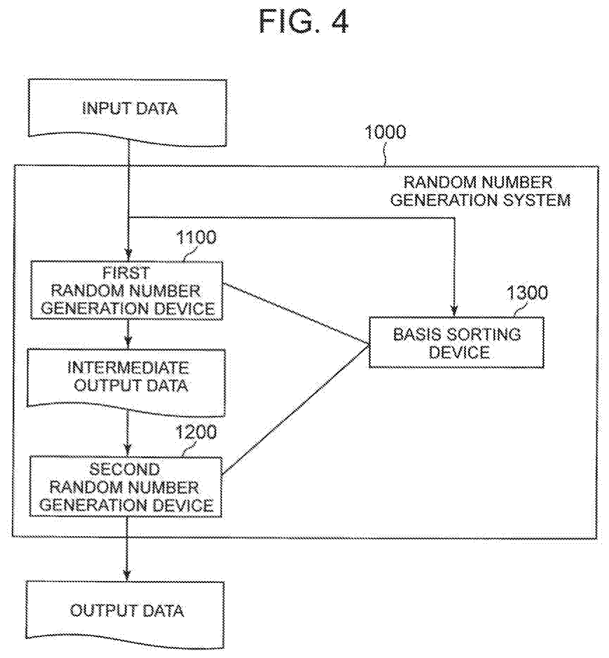

FIG. 4 is a block diagram showing a configuration example of a first exemplary embodiment of a random number generation system according to the present invention. As shown in FIG. 4, a random number generation system 1000 of the present exemplary embodiment includes a first random number generation device 1100, a second random number generation device 1200, and a basis sorting device 1300.

The random number generation system 1000 of the present exemplary embodiment executes an inverse image computation algorithm of a trapdoor one-way function, which is a base of the above-described encryption application technology. The random number generation system 1000 can execute the inverse image sampling process with high parallelism while suppressing memory consumption.

As shown in FIG. 4, input data including a security parameter, a center, and (3I₀+1) pieces of basis vector comprising the dual primitive lattice matrix S is inputted to the first random number generation device 1100 and the basis sorting device 1300. The first random number generation device 1100 is a device that generates a random number in accordance with the algorithm GPV shown in FIG. 1.

Further, the basis sorting device 1300 has a function of grouping basis vectors of the dual primitive lattice matrix S included in the input data. The basis sorting device 1300 notifies the first random number generation device 1100 of a basis vector that is to be an input of the algorithm GPV shown in FIG. 1.

Further, the basis sorting device 1300 notifies the second random number generation device 1200 of a basis vector that is to be an input of the algorithm superposition lattice sample shown in FIG. 3. The second random number generation device 1200 is a device that generates a random number in accordance with the algorithm RC sample shown in FIG. 2 and the algorithm superposition lattice sample shown in FIG. 3.

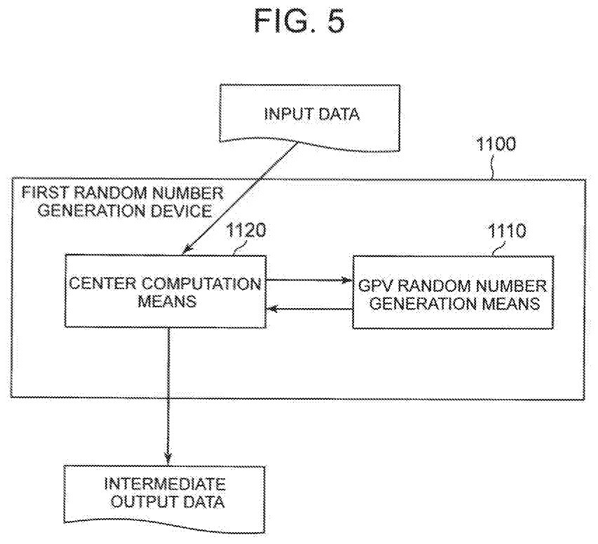

FIG. 5 is a block diagram showing a configuration example of the first random number generation device 1100 of the first exemplary embodiment. As shown in FIG. 5, the first random number generation device 1100 of the present exemplary embodiment has a GPV random number generation means 1110 and a center computation means 1120.

The GPV random number generation means 1110 has a function of generating a random number by executing step 4. of the algorithm Nearest_Plane_Sample shown in FIG. 1.

Further, the center computation means 1120 has a function of computing a center and a variance value of a one-dimensional discrete Gaussian distribution by executing steps 2. and 3. of the algorithm Nearest_Plane_Sample shown in FIG. 1. Further, the center computation means 1120 updates a center and the like of the one-dimensional discrete Gaussian distribution by executing steps 5. to 7. of the algorithm Nearest_Plane_Sample shown in FIG. 1 on the basis of a random number inputted from the GPV random number generation means 1110.

The input data inputted to the first random number generation device 1100 is passed to the center computation means 1120. The center computation means 1120 computes a center and a variance value of the one-dimensional discrete Gaussian distribution on the basis of a basis vector indicated by the notification content from the basis sorting device 1300.

The center computation means 1120 inputs the computed center and variance value of the one-dimensional discrete Gaussian distribution to the GPV random number generation means 1110. The GPV random number generation means 1110 generates a random number according to the one-dimensional discrete Gaussian distribution on the basis of the input value.

The GPV random number generation means 1110 inputs the generated random number to the center computation means 1120 again. The center computation means 1120 updates the center and the like of the one-dimensional discrete Gaussian distribution on the basis of the inputted random number.

The above operation is repeatedly executed for the number of basis vectors notified from the basis sorting device 1300, among the inputted basis vectors. Finally, the first random number generation device 1100 inputs intermediate output data including a random number according to the one-dimensional discrete Gaussian distribution whose center is (c^{→}−v^{→}), to the second random number generation device 1200.

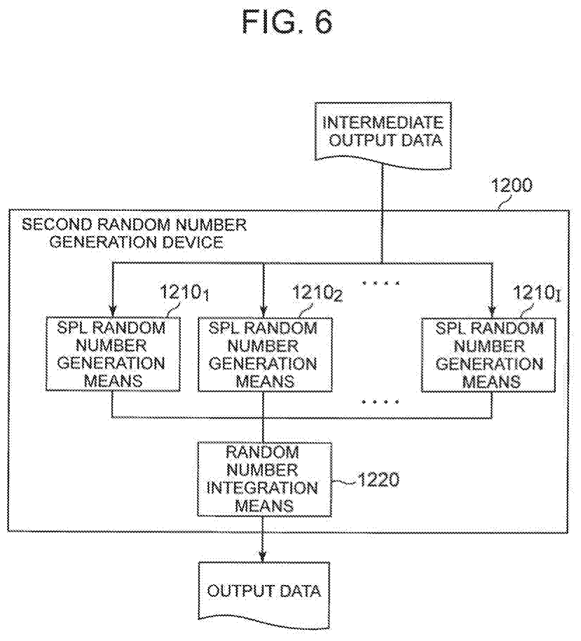

FIG. 6 is a block diagram showing a configuration example of the second random number generation device 1200 of the first exemplary embodiment. As shown in FIG. 6, the second random number generation device 1200 of the present exemplary embodiment has SPL random number generation means 1210₁ to 1210_{I} and a random number integration means 1220.

The intermediate output data inputted to the second random number generation device 1200 is inputted to each of the SPL random number generation means 1210₁ to 1210_{I}. Each of the SPL random number generation means 1210₁ to 1210_{I} has a function of generating a random number in accordance with the algorithm RC sample shown in FIG. 2 and the algorithm superposition lattice sample shown in FIG. 3.

Each of the SPL random number generation means 1210₁ to 1210_{I} generates a random number according to a one-dimensional discrete Gaussian distribution on the basis of a basis vector indicated by the notification content from the basis sorting device 1300. Specifically, the basis vectors indicated by the notification content are divided into each two pieces, and each set of the divided basis vectors is assigned to each of the SPL random number generation means 1210₁ to 1210_{I}.

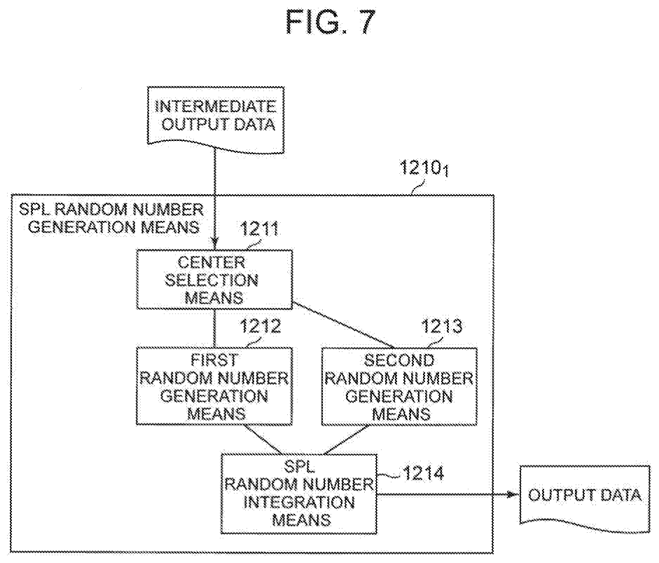

FIG. 7 is a block diagram showing a configuration example of the SPL random number generation means 1210₁ of the first exemplary embodiment. As shown in FIG. 7, the SPL random number generation means 1210₁ of the present exemplary embodiment includes a center selection means 1211, a first random number generation means 1212, a second random number generation means 1213, and an SPL random number integration means 1214. Note that a configuration of other SPL random number generation means is the same as the configuration of the SPL random number generation means 1210₁ shown in FIG. 7.

The center selection means 1211 has a function of appropriately selecting a center from an input value. Further, the center selection means 1211 executes steps 1. to 3. of the algorithm superposition lattice sample shown in FIG. 3.

The center selection means 1211 inputs a center, a variance value, and the lattice SPL₁ (a^{→}, b^{→}) or the lattice SPL₂ (a^{→}, b^{→}) obtained by the execution, to the first random number generation means 1212 and the second random number generation means 1213. That is, the center selection means 1211 instructs the first random number generation means 1212 and the second random number generation means 1213 whether to generate a random number according to the one-dimensional discrete Gaussian distribution on the lattice SPL₁ (a^{→}, b^{→}) or generate a random number according to the one-dimensional discrete Gaussian distribution on the lattice SPL₂ (a^{→}, b^{→}).

The first random number generation means 1212 has a function of generating a random number α according to a static one-dimensional discrete Gaussian distribution, by executing step 2. of the algorithm RC sample shown in FIG. 2. The first random number generation means 1212 generates the random number α by, for example, a cumulative method.

Further, the second random number generation means 1213 has a function of generating a random number β according to a static one-dimensional discrete Gaussian distribution, by executing step 3. of the algorithm RC sample shown in FIG. 2. The second random number generation means 1213 generates the random number β by, for example, a cumulative method.

The process of step 2. and the process of step 3. are independent, and thus can be executed in parallel. The first random number generation means 1212 and the second random number generation means 1213 input the generated random number to the SPL random number integration means 1214. The SPL random number integration means 1214 outputs data including the generated random number.

The random number integration means 1220 integrates the data outputted from each of the SPL random number generation means 1210₁ to 1210_{I} and the intermediate output data. Finally, the random number integration means 1220 outputs a content corresponding to the output when the algorithm GPV shown in FIG. 1 is executed as usual.

### [Description of Operation]

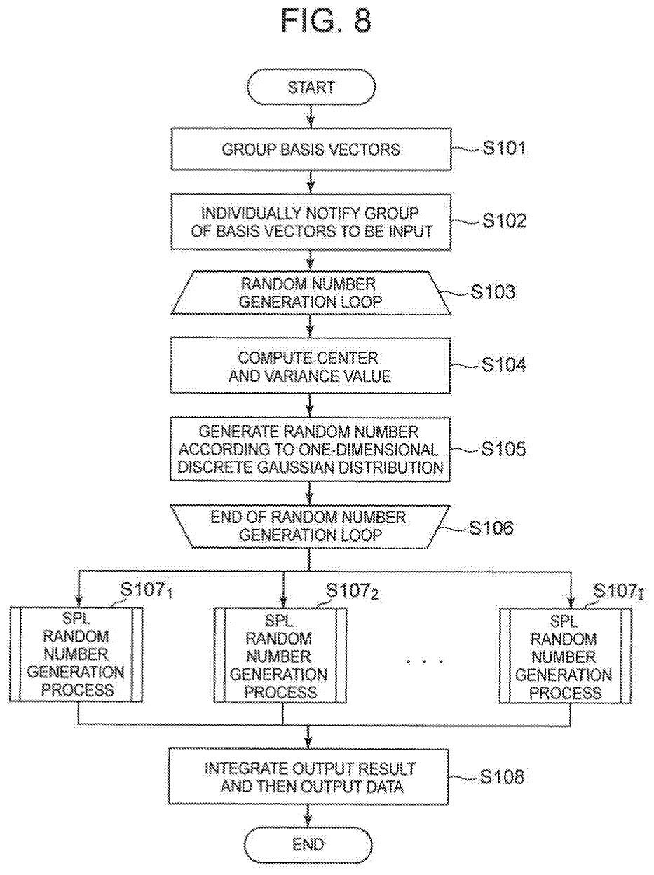

Hereinafter, an operation in which the random number generation system 1000 of the present exemplary embodiment generates a random number according to a discrete Gaussian distribution on a lattice will be described with reference to FIG. 8. FIG. 8 is a flowchart showing an operation of a random number generation process by the random number generation system 1000 of the first exemplary embodiment.

In this example, the dual primitive lattice matrix S is set as S=[s₁^{→}, . . . , s_{3I0}^{→}, sₙ^{→}]. First, the basis sorting device 1300 inputted with input data groups the basis vectors of the dual primitive lattice matrix S (step S101).

Specifically, the basis sorting device 1300 inputted with the input data changes an order of the basis vectors of the dual primitive lattice matrix S to [s₁^{→}, s₂^{→}, s₄^{→}, . . . , s_{3I0}^{→}, sₙ^{→}]. A Gram-Schmidt matrix of the dual primitive lattice matrix S is expressed as [s₁^{˜→}, s₂^{˜→}, s₄^{˜→}, . . . , s_{3I0}^{˜→}, sₙ^{˜→}]. Further, in this example, [s₃^{→}, s₆^{→}, . . . , s_{3I0}^{→}] is called an intermediate vector.

Note that the above dividing method of the basis vectors is the simplest dividing method. The basis sorting device 1300 may group the basis vectors by a method other than the above. Further, the basis vector to be the intermediate vector may not be a 3k-th basis vector (k is a natural number).

The basis sorting device 1300 notifies the first random number generation device 1100 that the above intermediate vector and sₙ^{→} are inputs of the algorithm GPV. Further, the basis sorting device 1300 notifies the second random number generation device 1200 that basis vectors other than the above intermediate vector and sₙ^{→} are inputs of the algorithm superposition lattice sample (step S102).

Next, the first random number generation device 1100 executes the algorithm GPV with the intermediate vector and sₙ^{→} as inputs. That is, the process enters a random number generation loop (step S103).

The center computation means 1120 computes a center and a variance value of the one-dimensional discrete Gaussian distribution on the basis of the inputted basis vector (step S104). Next, the center computation means 1120 inputs the computed center and variance value to the GPV random number generation means 1110.

Next, the GPV random number generation means 1110 generates a random number according to the one-dimensional discrete Gaussian distribution on the basis of the input value (step S105). Next, the GPV random number generation means 1110 inputs the generated random number to the center computation means 1120.

The first random number generation device 1100 repeatedly performs the processing of steps S104 and S105 while there is a basis vector not inputted to the algorithm Nearest_Plane_Sample, among the inputted basis vectors. When all the inputted basis vectors are inputted to the algorithm Nearest_Plane_Sample and all random numbers are generated, the first random number generation device 1100 exits the random number generation loop (step S106).

Next, the first random number generation device 1100 inputs the intermediate output data including the random number generated by the execution of the algorithm GPV, to the second random number generation device 1200.

The SPL random number generation means 1210₁ of the second random number generation device 1200 generates a random number in accordance with the algorithm superposition lattice sample on the basis of the inputted intermediate output data. That is, the SPL random number generation means 1210₁ performs an SPL random number generation process (step S107₁).

Similarly, the SPL random number generation means 1210₂ to 1210_{I} also perform the SPL random number generation process (steps S107₂ to S107_{I}). In this example, the individual SPL random number generation processes of steps S107₁ to S107_{I} are executed in parallel. In each of the SPL random number generation processes in steps S107₁ to S107_{I}, a random number according to the discrete Gaussian distribution on the following lattice is generated.

$$L ( {{s}^{->}}_{1} , {{s}^{->}}_{2} , {{s}^{->}}_{4} , {{s}^{->}}_{5} , … , {{s}^{->}}_{3 {I}_{0} - 2} , {{s}^{->}}_{3 {I}_{0} - 1} ) = {{⊕}^{{I}_{0}}}_{i = 1} L ( {{s}^{->}}_{3 i - 2} , {{s}^{->}}_{3 i - 1} ) \\ ( i ∈ [ {I}_{0} ] ) \qquad [ Formula 16 ]$$

Next, the random number integration means 1220 integrates the data outputted from the SPL random number generation means 1210₁ to 1210_{I} and the intermediate output data. After the integration, the random number integration means 1220 outputs data corresponding to an execution result of the algorithm GPV (step S108). After outputting the data, the random number generation system 1000 ends the random number generation process.

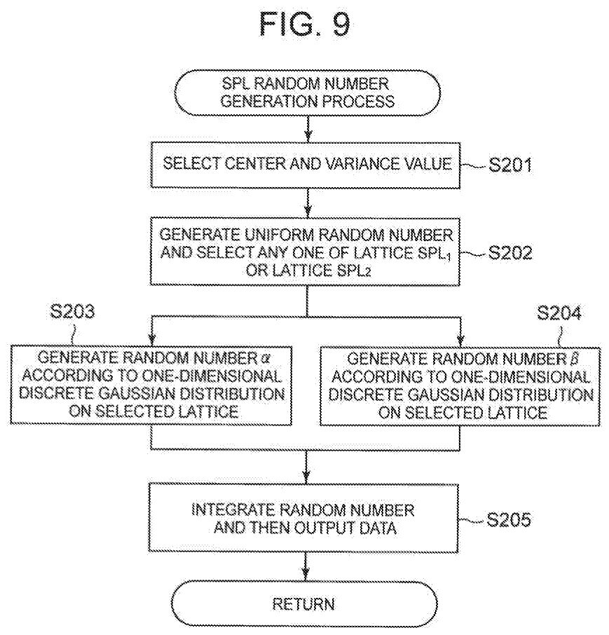

Next, an operation in which each of the SPL random number generation means 1210₁ to 1210_{I} generates a random number according to a static one-dimensional discrete Gaussian distribution will be described with reference to FIG. 9. FIG. 9 is a flowchart showing an operation of the SPL random number generation process by the SPL random number generation means of the first exemplary embodiment.

The center selection means 1211 selects a center and a variance value of the one-dimensional discrete Gaussian distribution (step S201). Next, the center selection means 1211 generates a uniform random number b.

When the generated uniform random number b is smaller than A/(A+B), the center selection means 1211 selects the lattice SPL₁. Further, when the generated uniform random number b is equal to or larger than A/(A+B), the center selection means 1211 selects the lattice SPL₂ (step S202). Note that the center selection means 1211 may compute A and B in advance.

Next, the center selection means 1211 inputs the selected center, variance value, and lattice to the first random number generation means 1212 and the second random number generation means 1213. The first random number generation means 1212 generates the random number α according to a static one-dimensional discrete Gaussian distribution on the selected lattice in accordance with the algorithm RC sample (step S203).

Further, the second random number generation means 1213 generates the random number β according to a static one-dimensional discrete Gaussian distribution on the selected lattice in accordance with the algorithm RC sample (step S204). As shown in FIG. 9, the random number generation process in step S203 and the random number generation process in step S204 are executed in parallel.

Next, the SPL random number integration means 1214 integrates the random number outputted from the first random number generation means 1212 and the random number outputted from the second random number generation means 1213. After the integration, the SPL random number integration means 1214 outputs data as an integration result (step S205). After outputting the data, the SPL random number generation means ends the SPL random number generation process.

As described above, in the SPL random number generation process, since the random number on the lattice comprising the SPL is generated, the process is completed by simply executing two processes of generating a random number according to a static one-dimensional discrete Gaussian distribution in parallel.

### [Description of Effect]

When a random number is generated using the random number generation system 1000 of the present exemplary embodiment, the following two effects are obtained. A first effect is that the number of calls of the discrete Gaussian distribution is reduced. The reason is that the number of executions of the algorithm for calling the dynamic discrete Gaussian distribution is reduced since the first random number generation means 1212 and the second random number generation means 1213 generate a plurality of random numbers in parallel.

As described above, in the method described in NPL 19, K times of call of the dynamic discrete Gaussian distribution are required. In the example shown in FIG. 8, it is assumed that the first random number generation device 1100 calls the dynamic discrete Gaussian distribution (1+K/3) times, and the second random number generation device 1200 calls the dynamic discrete Gaussian distribution once. That is, the number of calls of the dynamic discrete Gaussian distribution is reduced from K to (K/3+2) by parallelizing the random number generation.

A second effect is to enable the use of the static discrete Gaussian distribution. The reason is that the discrete Gaussian distribution required by the second random number generation device 1200 is at most a finite number (about 10), and a process of computing a value of a function that determines the discrete Gaussian distribution is a process that can be actually executed.

As described above, the random number generation system 1000 of the present exemplary embodiment realizes an increase of a speed of inverse image sampling, by generating random numbers according to the discrete Gaussian distribution in parallel and calling the static discrete Gaussian distribution more often.

Note that the random number generation system 1000 of the present exemplary embodiment may be realized by, for example, a processor such as a central processing unit (CPU) that executes processing in accordance with a program stored in a non-transitory storage medium, or by a data processing device. That is, the GPV random number generation means 1110, the center computation means 1120, the SPL random number generation means 1210₁ to 1210_{I}, the random number integration means 1220, and the basis sorting device 1300 may be realized, for example, by the CPU that executes processing in accordance with program control.

Further, each unit in the random number generation system 1000 of the present exemplary embodiment may be realized by a hardware circuit. As an example, the GPV random number generation means 1110, the center computation means 1120, the SPL random number generation means 1210₁ to 1210_{I}, the random number integration means 1220, and the basis sorting device 1300 are each realized by large scale integration (LSI). In addition, they may be realized by one LSI.

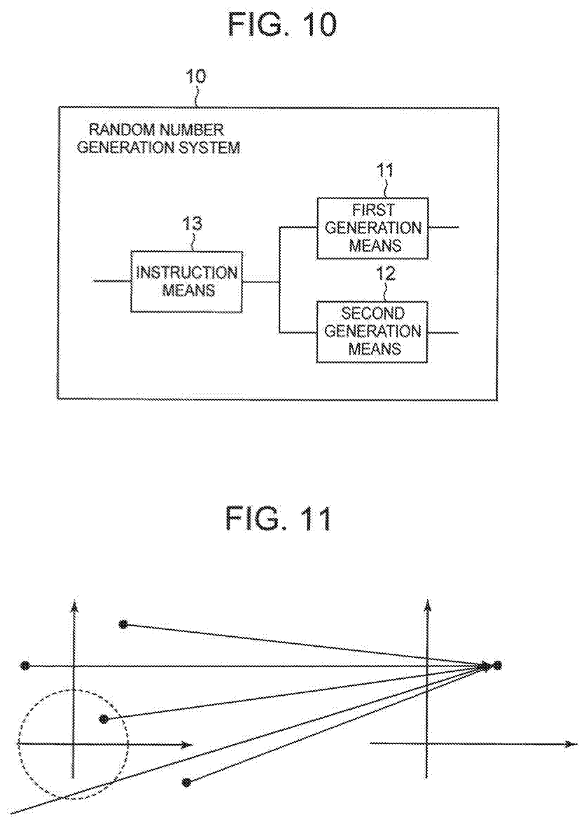

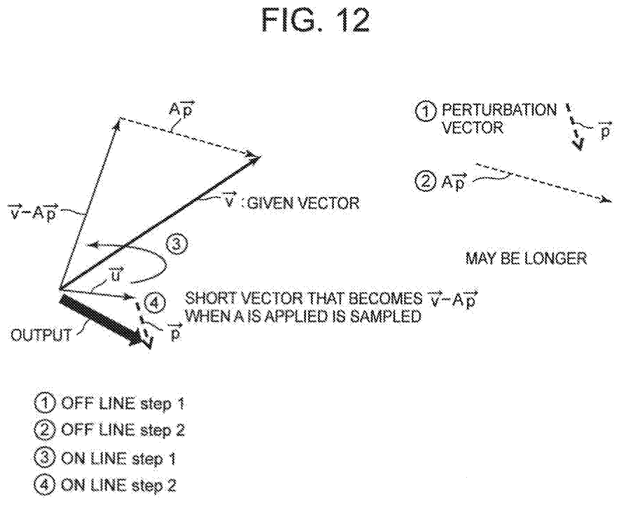

Next, an outline of the present invention will be described. FIG. 10 is a block diagram showing an outline of a random number generation system according to the present invention. A random number generation system 10 according to the present invention is a random number generation system that generates a random number according to a discrete Gaussian distribution on a lattice in which a first vector (for example, g^{→}) and a second vector (for example, h^{→}) that are two vectors having equal lengths are basis vectors. The random number generation system 10 includes: a first generation means 11 (for example, the first random number generation means 1212, the second random number generation means 1213) that generates a random number according to a one-dimensional discrete Gaussian distribution on a first lattice (for example, SPL₁ (g^{→}+h^{→}, g^{→}−h^{→}) that is a lattice comprising an addition vector (for example, g^{→}+h^{→}) obtained by adding the second vector to the first vector and a subtraction vector (for example, g^{→}−h^{→}) obtained by subtracting the second vector from the first vector; a second generation means 12 (for example, the first random number generation means 1212, the second random number generation means 1213) that generates a random number according to a one-dimensional discrete Gaussian distribution on a second lattice (for example, SPL₂ (g^{→}+h^{→}, g^{→}−h^{→})) that is the first lattice in which a vector obtained by dividing the sum of the addition vector and the subtraction vector by 2 is added (for example, {(g^{→}+h^{→})+(g^{→}−h^{→)}/}2); and an instruction means 13 (for example, the center selection means 1211) that instructs the first generation means 11 or the second generation means 12 to generate a random number.

Such a configuration allows the random number generation system to increase a computation speed of the inverse image sampling process performed on an arbitrary modulus.

Further, the first generation means 11 may generate a random number according to a one-dimensional discrete Gaussian distribution on the first lattice by a cumulative method, and the second generation means 12 may generate a random number according to a one-dimensional discrete Gaussian distribution on the second lattice by a cumulative method.

Such a configuration allows the random number generation system to further increase a computation speed of the inverse image sampling process.

In addition, the instruction means 13 may individually compute a first probability (for example, A) that is a probability that a random number is generated on the first lattice, and a second probability (for example, B) that is a probability that a random number is generated on the second lattice; generate a uniform random number (for example, b); instruct the first generation means 11 to generate a random number when the generated uniform random number is smaller than a ratio of the computed first probability to a sum of the computed first probability and the computed second probability; and instruct the second generation means 12 to generate a random number when the generated uniform random number is equal to or more than the ratio.

Such a configuration allows the random number generation system to generate a random number with more accurate probability.

Further, the random number generation system 10 may include a selection means (for example, the center selection means 1211) that selects a center and a variance value of the one-dimensional discrete Gaussian distribution, and the selection means may input the selected center and variance value to the first generation means 11 or the second generation means 12.

Such a configuration allows the random number generation system to further increase a computation speed of the inverse image sampling process.

Although the present invention has been described with reference to the exemplary embodiment and examples, the present invention is not limited to the above exemplary embodiment and examples. Various changes that can be understood by those skilled in the art can be made to the configuration and details of the present invention within the scope of the present invention.

### INDUSTRIAL APPLICABILITY

The present invention can efficiently generate a signature, and thus can be suitably applied to signature generation processing. Further, the present invention can be suitably applied to encryption application technologies such as ABE and IBE.

### REFERENCE SIGNS LIST

10, 1000 Random number generation system

11 First generation means

12 Second generation means

13 Instruction means

1100 First random number generation device

1110 GPV random number generation means

1120 Center computation means

1200 Second random number generation device

1210₁ to 1210_{I} SPL random number generation means

1211 Center selection means

1212 First random number generation means

1213 Second random number generation means

1214 SPL random number integration means

1220 Random number integration means

1300 Basis sorting device

What is claimed is:

1. A random number generation system that generates a random number according to a discrete Gaussian distribution on a lattice in which a first vector and a second vector that are two vectors having equal lengths are basis vectors, the random number generation system comprising:
a first generation unit, implemented by a hardware including one or more processors, which generates a random number according to a one-dimensional discrete Gaussian distribution on a first lattice that is a lattice comprising an addition vector obtained by adding the second vector to the first vector and a subtraction vector obtained by subtracting the second vector from the first vector;
a second generation unit, implemented by the hardware, which generates a random number according to a one-dimensional discrete Gaussian distribution on a second lattice that is the first lattice in which a vector obtained by dividing the sum of the addition vector and the subtraction vector by 2 is added; and
an instruction unit, implemented by the hardware, which instructs the first generation unit or the second generation unit to generate a random number.

2. The random number generation system according to claim 1, wherein
the first generation unit generates a random number according to a one-dimensional discrete Gaussian distribution on the first lattice by a cumulative method, and
the second generation unit generates a random number according to a one-dimensional discrete Gaussian distribution on the second lattice by a cumulative method.

3. The random number generation system according to claim, wherein
the instruction unit;
individually computes a first probability that is a probability that a random number is generated on the first lattice, and a second probability that is a probability that a random number is generated on the second lattice;
generates a uniform random number;
instructs the first generation unit to generate a random number when the generated uniform random number is smaller than a ratio of the computed first probability to a sum of the computed first probability and the computed second probability; and
instructs the second generation unit to generate a random number when the generated uniform random number is equal to or more than the ratio.

4. The random number generation system according to claim 1, further comprising:
a selection unit, implemented by the hardware, which selects a center and a variance value of a one-dimensional discrete Gaussian distribution, wherein
the selection unit inputs the selected center and variance value to the first generation unit or the second generation unit.

5. A computer-implemented random number generation method executed in a random number generation system that generates a random number according to a discrete Gaussian distribution on a lattice in which a first vector and a second vector that are two vectors having equal lengths are basis vectors, wherein
the random number generation method generates a random number by executing any one of:
a first generation process of generating a random number according to a one-dimensional discrete Gaussian distribution on a first lattice that is a lattice comprising an addition vector obtained by adding the second vector to the first vector and a subtraction vector obtained by subtracting the second vector from the first vector; or a second generation process of generating a random number according to a one-dimensional discrete Gaussian distribution on a second lattice that is the first lattice in which a vector obtained by dividing the sum of the addition vector and the subtraction vector by 2 is added.

6. The computer-implemented random number generation method according to claim 5, wherein
in the first generation process, a random number according to a one-dimensional discrete Gaussian distribution on the first lattice is generated by a cumulative method, and
in the second generation process, a random number according to a one-dimensional discrete Gaussian distribution on the second lattice is generated by a cumulative method.

7. The computer-implemented random number generation method according to claim 5, wherein
a first probability that is a probability that a random number is generated on the first lattice, and a second probability that is a probability that a random number is generated on the second lattice are individually computed,
a uniform random number is generated,
the first generation process is executed when the generated uniform random number is smaller than a ratio of the computed first probability to a sum of the computed first probability and the computed second probability, and
the second generation process is executed when the generated uniform random number is equal to or more than the ratio.

8. A non-transitory computer-readable capturing medium having captured therein a random number generation program executed in a computer that generates a random number according to a discrete Gaussian distribution on a lattice in which a first vector and a second vector that are two vectors having equal lengths are basis vectors, the random number generation program causing
the computer to
execute a generation process of generating a random number by executing any one of:
a first generation process of generating a random number according to a one-dimensional discrete Gaussian distribution on a first lattice that is a lattice comprising an addition vector obtained by adding the second vector to the first vector and a subtraction vector obtained by subtracting the second vector from the first vector; or a second generation process of generating a random number according to a one-dimensional discrete Gaussian distribution on a second lattice that is the first lattice in which a vector obtained by dividing the sum of the addition vector and the subtraction vector by 2 is added.

9. The non-transitory computer-readable capturing medium according to claim 8, wherein
the random number generation program causes the computer to:
generate, in the first generation process, a random number according to a one-dimensional discrete Gaussian distribution on the first lattice by a cumulative method, and
generate, in the second generation process, a random number according to a one-dimensional discrete Gaussian distribution on the second lattice by a cumulative method.

10. The non-transitory computer-readable capturing medium according to claim 8, wherein
the random number generation program
causes the computer to execute:
a computation process of individually computing a first probability that is a probability that a random number is generated on the first lattice, and a second probability that is a probability that a random number is generated on the second lattice; and
a uniform random number generation process of generating a uniform random number, and
causes the computer to execute, in a generation process, the first generation process when the generated uniform random number is smaller than a ratio of the computed first probability to a sum of the computed first probability and the computed second probability, and the second generation process when the generated uniform random number is equal to or more than the ratio.

11. The random number generation system according to claim 2, wherein
the instruction unit:
individually computes a first probability that is a probability that a random number is generated on the first lattice, and a second probability that is a probability that a random number is generated on the second lattice;
generates a uniform random number;
instructs the first generation unit to generate a random number when the generated uniform random number is smaller than a ratio of the computed first probability to a sum of the computed first probability and the computed second probability; and
instructs the second generation unit to generate a random number when the generated uniform random number is equal to or more than the ratio.

12. The random number generation system according to claim 2, further comprising:
a selection unit, implemented by the hardware, which selects a center and a variance value of a one-dimensional discrete Gaussian distribution, wherein
the selection unit inputs the selected center and variance value to the first generation unit or the second generation unit.

13. The random number generation system according to claim 3, further comprising:
a selection unit, implemented by the hardware, which selects a center and a variance value of a one-dimensional discrete Gaussian distribution, wherein
the selection unit inputs the selected center and variance value to the first generation unit or the second generation unit.

14. The random number generation system according to claim 11, further comprising:
a selection unit, implemented by the hardware, which selects a center and a variance value of a one-dimensional discrete Gaussian distribution, wherein
the selection unit inputs the selected center and variance value to the first generation unit or the second generation unit.

15. The computer-implemented random number generation method according to claim 6, wherein
a first probability that is a probability that a random number is generated on the first lattice, and a second probability that is a probability that a random number is generated on the second lattice are individually computed,
a uniform random number is generated,
the first generation process is executed when the generated uniform random number is smaller than a ratio of the computed first probability to a sum of the computed first probability and the computed second probability, and
the second generation process is executed when the generated uniform random number is equal to or more than the ratio.

16. The non-transitory computer-readable capturing medium according to claim 9, wherein
the random number generation program
causes the computer to execute:
a computation process of individually computing a first probability that is a probability that a random number is generated on the first lattice, and a second probability that is a probability that a random number is generated on the second lattice; and
a uniform random number generation process of generating a uniform random number, and
causes the computer to execute, in a generation process, the first generation process when the generated uniform random number is smaller than a ratio of the computed first probability to a sum of the computed first probability and the computed second probability, and the second generation process when the generated uniform random number is equal to or more than the ratio.
